(19) United States
(12) Patent Application Publication
(10) Pub. No.: US 2023/0347189 A1
(43) Pub. Date: Nov. 2, 2023

(54) Independent Control of Effective Pore Diameter and Porosity of Masking Material to Increase Particle Capture and Breathing Easiness

(71) Applicant: UNM Rainforest Innovations, Albuquerque, NM (US)

(72) Inventors: Sang Eon Han, Albuquerque, NM (US); Sang M. Han, Albuquerque, NM (US); Bokyung Park, Albuquerque, NM (US)

(73) Assignee: UNM Rainforest Innovations, Albuquerque, NM (US)

(21) Appl. No.: 18/308,636

(22) Filed: Apr. 27, 2023

Related U.S. Application Data
(60) Provisional application No. 63/335,453, filed on Apr. 27, 2022.

(51) Int. Cl. A62B 23/02

(52) U.S. Cl. CPC A62B 23/025

(57) ABSTRACT

A mask system, apparatus, device, and methods that increase both the screening efficiency and breathing easiness.

### RELATED APPLICATIONS

This application claims priority to U.S. Provisional Application No. 63/335453, filed on Apr. 27, 2022, which is incorporated herein in its entirety.

### STATEMENT REGARDING FEDERALLY SPONSORED RESEARCH & DEVELOPMENT

This invention was made with government support by the National Science Foundation grant DMR1555290. The government has certain rights in the invention.

### INCORPORATION BY REFERENCE OF MATERIAL SUBMITTED ON A COMPACT DISC

Not applicable.

### BACKGROUND OF THE INVENTION

Respirator masks screen airborne particulate matter such as dirt, dust, soot as well as liquid droplets containing virus. In general, as efficiency of particle screening increases, breathing becomes harder because of an increased pressure difference across the mask.

Respirator masks are manufactured typically by melt blowing and electrospinning. These methods result in fibers randomly oriented in the mask plane. FIG. 1 shows a schematic top view of the mask microstructure of three different fiber diameters at the same porosity of 0.9.

When the fiber diameter is sufficiently small, the size of a particle (shaded circle) is greater than that of a typical pore so that screening is highly effective (left panel). As the fiber diameter increases (middle and right panels), the typical pore size also increases, admitting the particle to be transmitted. Because the porosity is large, breathing would be easy for all fiber diameters at a typical mask thickness.

However, as the fiber diameter decreases, the mask becomes weak mechanically. For a reasonable balance between the screening efficiency and mechanical strength, typical N95 respirator masks in the current market have a mean fiber diameter 3 - 20 um. The mean pore size of these masks can be as large as ~400 um, which is inefficient in screening submicron particles.

### BRIEF SUMMARY OF THE INVENTION

In one embodiment, the present invention provides a system, apparatus, device, and methods that increase both the screening efficiency and breathing easiness.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is a schematic illustration of particle screening efficiency and mechanical strength of respirator masks with different fiber diameters at the same porosity.

FIG. 2 is an electron micrograph top-view images of electrospun fiber mats with varying mean fiber diameters at a porosity of ~0.9 for embodiments of the present invention.

FIG. 3A shows a mask fabricated by co-deposition of thin and thick fibers for an embodiment of the present invention.

FIG. 3B shows a masks fabricated by layered deposition for an embodiment of the present invention.

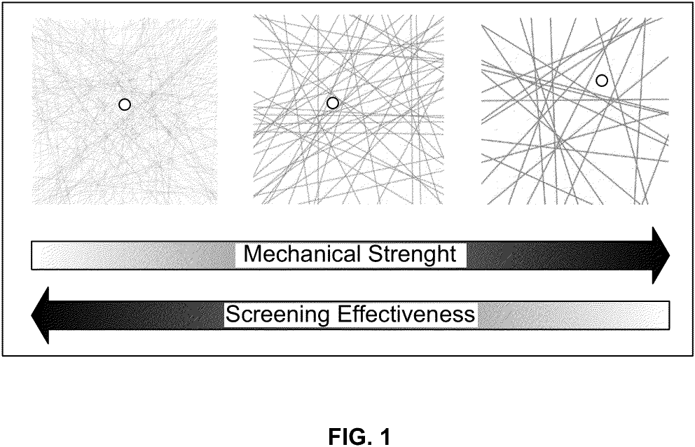

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In a preferred embodiment, the present invention concerns a mask having a mean fiber diameter that ranges from 0.187 um to 1.757 um at a porosity of ~0.9. Thus, the fiber diameter can be more than one or two orders of magnitude smaller than that in commercial N95 masks, so that the screening efficiency for small submicron particles, such as viruses (~0.1 um) after the encapsulating water droplet has evaporated in the mask, would be significantly greater.

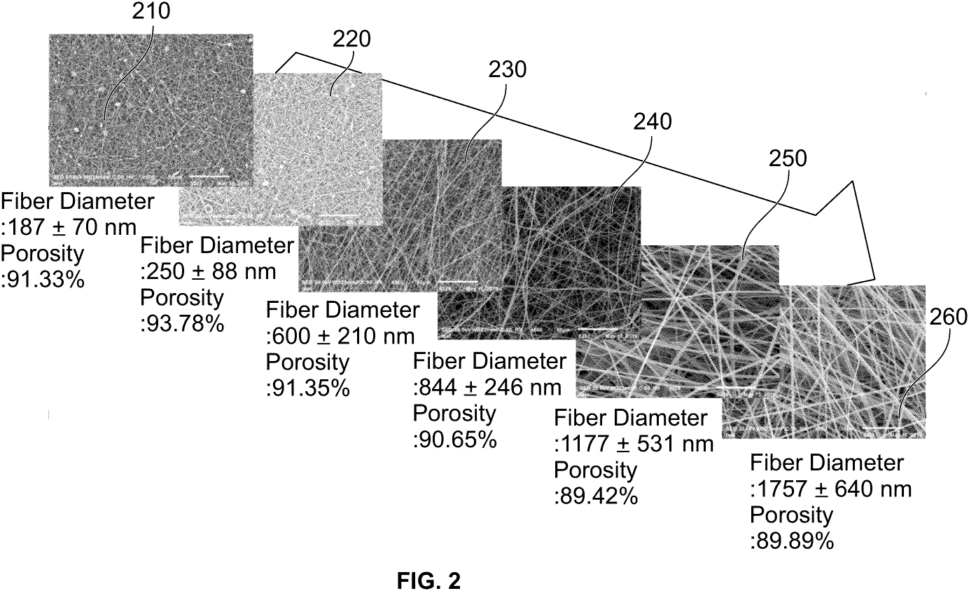

In another preferred embodiment, the present invention concerns a method of making the above-referenced mask. The method has the capability of independently controlling a mean fiber diameter and porosity by electrospinning. For example, FIG. 2 displays electron micrograph top-view images of electrospun fiber mats of the present invention, where a mean fiber diameter ranges from 0.187 um to 1.757 um at a porosity of ~0.9. Specifically, mask 210 has a fiber diameter size of 187 ± 70 um with a porosity of 91.33%. Mask 220 has a fiber diameter size of 250 ± 88 um with a porosity 93.87%. Mask 230 has a fiber diameter size of 600 ± 210 um with a porosity of 91.35%. Mask 240 has a fiber diameter size of 844 ± 246 um with a porosity of 90.65%. Mask 250 has a fiber diameter size of 1177 ± 531 um with the porosity of 89.42%. Mask 260 has a fiber diameter size of 1767 ± 640 um with a porosity of 89.89%. All of the masks have a screening efficiency for small submicron particles, such as viruses (~0.1 um). However, as the fiber diameter decreases to a deep submicron scale, the mechanical strength of the mask can become a problem.

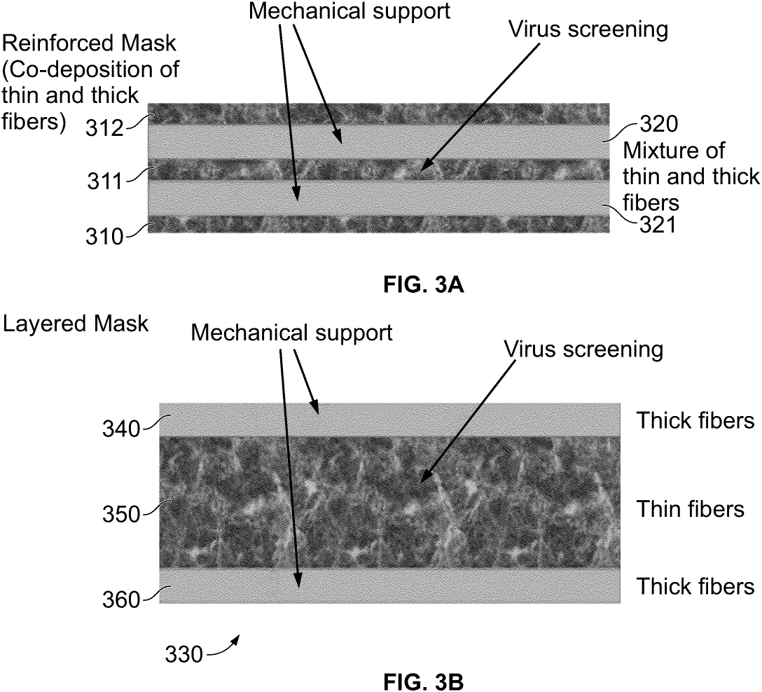

In other embodiments, the present invention provides mask having enhanced strength while retaining the benefits described above. As shown in FIGS. 3A and 3B, to enhance the mechanical strength of the padding used to be configured into a mask, while maintaining a high screening efficiency, fibers of small (~0.2 um) and large (~20 um) diameters may be used. As shown in FIG. 3A, small (~0.2 um) fibers 310-312 and large (~20 um) fibers 320 and 321 can be co-deposited onto a surface. In other embodiments, fibers 310-312 may form unwoven layers and supporting layers 320 and 321 may be woven layers. Fiber layers 320 and 321 are used to add mechanical support to the mask material without impeding air flow.

Another embodiment is shown in FIG. 3B. For this embodiment, layered matt 330 is comprised of a layer of large diameters fibers 340, a layer of small diameter fibers 350 and a layer of large diameter fibers 360. In other embodiments, fiber 350 may form an unwoven layer and supporting layers 340 and 360 may be woven layers. Fiber layers 340 and 360 are used to add mechanical support to the mask material without impeding air flow.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A mask having a mean fiber diameter range from 187 nanometers to 1.757 um and a porosity of around 90%.

2. The mask of claim 1 having a fiber diameter size of 187 ± 70 nm with a porosity of 91.33%.

3. The mask of claim 1 having a fiber diameter size of 250 ± 88 nm with a porosity 93.87%.

4. The mask of claim 1 having a fiber diameter size of 600 ± 210 nm with a porosity of 91.35%.

5. The mask of claim 1 having a fiber diameter size of 844 ± 246 nm with a porosity of 90.65%.

6. The mask of claim 1 having a fiber diameter size of 1177 ± 531 nm with the porosity of 89.42%.

7. The mask of claim 1 having a fiber diameter size of 1767 ± 640 nm with a porosity of 89.89%.

8. The mask of claim 1 having a fiber diameter size of 187 ± 70 nm with a porosity of 91.33% and a screening efficiency for small submicron particles, such as viruses (~0.1 um).

9. The mask of claim 1 having a fiber diameter size of 250 ± 88 nm with a porosity 93.87% and a screening efficiency for small submicron particles, such as viruses (~0.1 um).

10. The mask of claim 1 having a fiber diameter size of 600 ± 210 nm with a porosity of 91.35% and a screening efficiency for small submicron particles, such as viruses (~0.1 um).

11. The mask of claim 1 having a fiber diameter size of 844 ± 246 nm with a porosity of 90.65% and a screening efficiency for small submicron particles, such as viruses (~0.1 um).

12. The mask of claim 1 having a fiber diameter size of 1177 ± 531 nm with the porosity of 89.42% and a screening efficiency for small submicron particles, such as viruses (~0.1 um).

13. The mask of claim 1 having a fiber diameter size of 1767 ± 640 nm with a porosity of 89.89% and a screening efficiency for small submicron particles, such as viruses (~0.1 um).

14. A mask comprised of small diameter fibers (~0.2 um) and large diameter fibers (~20 um) and a screening efficiency for small submicron particles, such as viruses (~0.1 um).

15. The mask of claim 14 wherein said small diameter fibers (~0.2 um) and said large diameter fibers (~20 um) are co-deposited onto a surface.

16. The mask of claim 14 comprised of a layer of large diameters fibers, a layer of small diameter fibers and a layer of large diameter fibers.
